(19) United States
(12) Patent Application Publication
(10) Pub. No.: US 2010/0212837 A1
(43) Pub. Date: Aug. 26, 2010

(54) CRAFT BEAD ROLLER AND METHOD OF MAKING A CRAFT BEAD FROM A STRIP OF MATERIAL

(76) Inventor: Vicki L. Dehne, Bel Air, MD (US)

Correspondence Address: SHERR & VAUGHN, PLLC, 620 HERNDON PARKWAY, SUITE 320, HERNDON, VA, 20170, US

(21) Appl. No.: 12/550,510

(22) Filed: Aug. 31, 2009

Related U.S. Application Data
(60) Provisional application No. 61/155,655, filed on Feb. 26, 2009.

(51) Int. Cl. B32B 38/00

(52) U.S. Cl. 156/450

(57) ABSTRACT

A bead roller is provided for manually crafting a bead from a strip of material. The bead roller may include at least one of a handle having a gripping surface adapted to be engaged by a hand of a user of the bead roller; and a tool arm extending from the handle and having an elongated body with a concave cross-section, and first and second parallel extending edges extending spaced apart along the longitudinal axis of the elongated body to define a slot, each edge having a surface adapted to engage a distal end of the strip of material when the material strip is received in the slot.

The present application claims the benefit under 35 U.S.C. §119(e) to U.S. Provisional Application Ser. No. 61/155,655, filed Feb. 26, 2009.

### BACKGROUND

Beading is a type of craft activity involving, for example, the creation of decorative articles such as jewelry, purses, baskets, wall hangings, etc. using one or more decorative objects called beads. The beads may be composed of various materials such as ceramics, polymers, stone, resins, paper and the like that have a semi-circular cross-section with a hole located in the center thereof and inserting a length of thread or wire through the hole.

During a process of creating one or more beads, a paper and/or composite material is cut into streams or strips of various lengths, each strip having a specific geometric shape. Each individual strip may then be wound into a bead having a semi-circular-type geometric shape. Depending on the length of the material strip and/or the intended decorative article to be created, each bead may range in size from several centimeters to several centimeters in diameter.

### SUMMARY

Embodiments are related to an apparatus for manually crafting beads in a more efficient fashion, thereby giving a user of the apparatus the ability to create several decorative articles in a shorten time period.

Embodiments are related to an apparatus for manually crafting beads having a geometric shape and size that does not produce undue stress and/or cramping of the hands and fingers, thereby making it a more enjoyable process.

Embodiments are related to an apparatus for manually crafting beads of uniform diameter, thereby producing a decorative article of professional quality.

Embodiments are related to an apparatus for manually crafting beads that is lightweight and composed of durable materials.

In accordance with embodiments, a bead roller is provided and adapted to craft a bead from a strip of material, the bead roller including at least one of the following: a handle having a gripping surface adapted for manipulation by a hand of a user of the bead roller, and a tool arm extending from a distal end of the handle, the tool arm having an elongated body of substantially semi-circular cross-section and a slot extending along a longitudinal axis thereof which is adapted to receive a distal end of the strip of material.

In accordance with embodiments, an apparatus for making a bead from a strip of material may include at least one of the following: a handle having a first handle portion of a first diameter and a second handle portion of a second diameter which is greater than the first diameter, the second handle portion having a having a gripping surface adapted for manipulation by a hand of a user of the bead roller; and a tool arm extending from the first handle portion, the tool arm having a body of substantially semi-circular cross-section with a longitudinal slot extending along its axis which is adapted to receive a distal end of the strip of material.

In accordance with embodiments, a bead roller is provided and adapted to craft a bead from a strip of material, the bead roller including at least one of the following: a handle having a gripping surface adapted for manipulation by a hand of a user of the bead roller; and a tool arm having a first tool arm portion extending from the handle, and a second tool arm portion extending from the first tool arm portion and having an elongated slot extending along its longitudinal axis which is adapted to receive a distal end of the strip of material.

In accordance with embodiments, a method of crafting a bead from a strip of material may include at least one of the following: providing a bead roller having a handle with a gripping surface and a tool arm extending from the handle, the tool arm having a slot extending along its longitudinal axis; and then inserting a distal end of the strip of material into the slot of the tool arm and applying tension on the opposite end of the strip of material; and then performing a first manipulation of the bead roller by rotating the bead roller while reducing the tension on the opposite end of the strip of material; and then stopping the first manipulation once the strip of material is at a predetermined remaining length; and then applying an adhesive to the bottom surface of the predetermined remaining length of the strip of material; and then performing a second manipulation of the bead roller by rotating the bead roller while simultaneously applying the adhesive to the top surface of the bead of material; and then remove the bead of material from the bead roller.

In accordance with embodiments, a bead roller is provided and adapted to craft a bead from a strip of material, the bead roller including at least one of the following: a handle having a gripping surface; a tool arm having a first tool arm portion extending from the handle and a second tool arm portion extending from the first tool arm portion, the second tool arm portion including a body having a first edge and a second edge extending along the longitudinal axis thereof, the second edge extending spaced apart from the first edge to define a slot sized to receive an end portion of the strip of material which engages a surface of one of the first edge and the second edge when the material strip is received in the slot.

In accordance with embodiments, a bead roller is provided and adapted to craft a bead from a strip of material, the bead roller including at least one of the following: a handle having a first handle portion of a first diameter and a second handle portion of a second diameter which is greater than the first diameter, the second handle portion having a having a gripping surface to be engaged by a user of the bead roller; and a tool arm extending from the first handle portion, the tool arm having a body with a concave cross-section and a first edge extending along the longitudinal axis of the body, a second edge extending along the longitudinal axis of the body and parallel to and spaced apart from the first edge to define a slot sized to receive a end portion of the strip of material, the first edge and the second edge each having a surface adapted to engage a distal end of the strip of material when the material strip is received in the slot.

In accordance with embodiments, a bead roller is provided and adapted to craft a bead from a strip of material, the bead roller including at least one of the following: a handle having a gripping surface adapted to be engaged by a hand of a user of the bead roller; and a tool arm extending from the handle and having an elongated body with a concave cross-section, and first and second parallel extending edges extending spaced apart along the longitudinal axis of the elongated body to define a slot, each edge having a surface adapted to engage a distal end of the strip of material when the material strip is received in the slot.

### DRAWINGS

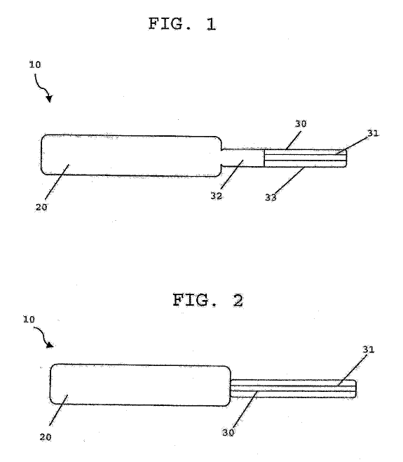

Example FIGS. 1-7 illustrate a bead roller and a method of crafting a bead from a strip of material, in accordance with embodiments.

### DESCRIPTION

As illustrated in example FIGS. 1-5, in accordance with embodiments, bead roller 10 is provided for permitting a user to craft one or more beads from material strip M composed of paper, a polymer, cloth, a composite and the like. Bead roller 10 may include handle 20 and tool arm 30 which extends from handle 30 along a longitudinal axis thereof.

Handle 20 may have a gripping surface adapted for manipulation by a hand of the user. Such gripping surface may include providing a polymeric layer which surrounds or otherwise shrouds the entire out surface of handle 20. The geometric shape and size of handle 20 is such that it permits the use of a natural and ergonomically stable hand grip when beading material strip M. Accordingly, the manipulation of bead roller 10 through the rotation of handle 20 does not produce undue stress and/or cramping of the hands and/or fingers.

As illustrated in example FIG. 1, handle 20 may have a uniform diameter of substantially rectangular cross-section. Although handle 20 is shown having a geometric shape with a substantially rectangular cross-section, it is not limited thereto and thus, may encompass any shape that enables a natural and ergonomically stable grip.

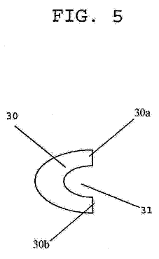

Tool arm 30 may extend from or is otherwise attached to a distal end of handle 20. As illustrated in example FIG. 5, tool arm 30 may have an elongated body with a concave or convex shape cross-section. Tool arm 30 may be composed of a durable material such as a metal, a polymer a composite and/or any combination thereof.

Due to its convex or convex cross-section, tool arm 30 may have spaced apart opposing edges 30a, 30b which define slot 31. Slot 31 may extend along a longitudinal axis of tool arm 30. Opposing edges 30a, 30b provide tool arm 30 to have a radius of curvature which enables an end portion of material strip M to be received in slot 31 and engage one of edges 30a, 30b to thereby initiate the beading process. By engaging one of edges 30a, 30b, material strip M may be wound around tool arm 30.

In accordance with embodiments, tool arm 30 may have first tool arm portion 32 and second tool arm portion 33. First tool arm portion 32 maybe a sleeve or shaft which extends directly from handle 20. First tool arm portion 32 may have a length of 1 inches, but is not limited thereto. Second tool arm portion 33 may extend directly from first tool arm portion 32. Second tool arm portion 33 may have a length of 1.5 inches, but is not limited thereto. Second tool arm portion 33 may have opposing edges 30a, 30b defining slot 31 which extends along a longitudinal axis. Second tool arm portion 33 may have a radius of curvature that permits an end portion of material strip M to engage it to thereby initiate the beading process such that material strip M is wound around tool arm 30.

Slot 31 and second tool arm portion 33 may have the same length, but is not limited thereto. Although first tool arm portion 32 is illustrated having a length less than second tool arm portion 33, embodiments may include bead roller 10 having first tool arm portion 32 with a length greater than or equal to the length of second tool arm portion 33. As illustrated in example FIG. 2, slot 31 may extend along the entire length of tool arm 30. In such case, the overall length of tool arm 30, and thus, slot 31, may be 2.5 inches, but is not limited thereto.

In accordance with embodiments, tool arm 30 may be attached to handle 20 or first handle portion 21 using an adhesive and/or by any mechanical connection. For instance, tool arm 30 may be press fit into a hole at the distal end of handle 20. Such press fit connection may include an adhesive to secure tool arm 30 to handle 20 or a sleeve received into the hole of handle 20 which in turn receives a end of tool arm 30.

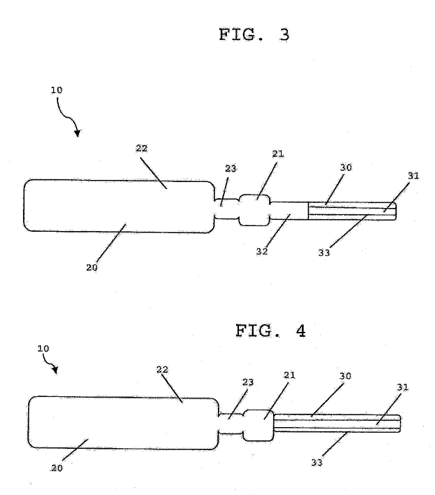

As illustrated in example FIG. 3, handle 20 may include first handle portion 21, second handle portion 22 and intermediate handle portion 23 which extends between first handle portion 21 and second handle portion 22. First handle portion has a first diameter and second handle portion 22 of a second diameter. In accordance with embodiments, the second diameter of second handle portion 22 may be greater than the first diameter of first handle portion 21. The second diameter of second handle portion 22 may be 0.75 inches, but is not limited thereto. First handle portion 21 and/or second handle portion 22 may have a gripping surface adapted for manipulation by a hand of a user. Such gripping surface may include providing a polymeric layer which surrounds or otherwise shrouds the entire out surface of handle 20. Accordingly, second handle portion 22 may be sized to enable a natural and ergonomically stable hand grip when beading material strip M.

Tool arm 30 may extend from or is otherwise attached to a distal end of first handle portion 21. Tool arm 30 may have first tool arm portion 32 and second tool arm portion 33. First tool arm portion 32 may extend directly from handle 20 at a length of 1 inches. Second tool arm portion 33 may extend directly from first tool arm portion 32 at a length of 1.5 inches. Second tool arm portion 33 may be provided with elongated slot 31 along its longitudinal axis which is adapted to receive an end portion of strip of material M. Slot 31 and second tool arm portion 33 may have the same length, but is not limited thereto.

As illustrated in example FIG. 4, slot 31 may extend along the entire length of tool arm 30. In such case, tool arm 30 and slot 31 may have a length of 2.5 inches, but is not limited thereto.

Handle 20 in accordance with embodiments as illustrated in example FIGS. 3 and 4 may have an overall length of 5.5 inches, but is not limited thereto. Handle 20 may be composed of one or more lightweight, durable materials. Handle 20 may be composed of a transparent material. Handle 20 may be composed of a wood material, polymeric material, ceramic material and any composite thereof. In accordance with embodiments, however, handle 20 is not limited to these materials and may be composed of any lightweight, yet durable material.

As illustrated in example FIGS. 3 and 4, tool arm 30 may extend from or is otherwise attached to a distal end of first handle portion 21. As illustrated in example FIG. 2, tool arm 30 may extend or is otherwise attached to handle 20. Tool arm 30 may be attached to handle 20 or first handle portion 21 using an adhesive and/or by mechanical connection and/or by press fitting a distal end of tool arm 30 into a hole at the distal end of handle 20 or first handle portion 21. Such press fit connection may include an adhesive to secure tool arm 30 to handle 20. Tool arm 30 may be composed of a durable material such as a metal, a polymer a composite, and any combination thereof.

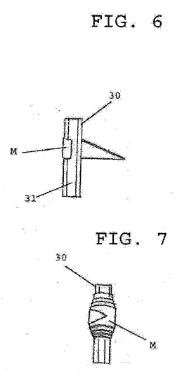

As illustrated in example FIGS. 6 and 7, a method of crafting a bead from a strip of material M may include inserting a distal end of the strip of material M into slot 31 of tool arm 30. Tension may be applied on the opposite end of the strip of material M. A first manipulation of bead roller 10 may be performed by simultaneously rotating bead roller 10 and reducing the tension on the opposite end (i.e., the end not received in slot 31) of the strip of material M. Depending upon the overall length of material strip M, such first manipulation may include rotating bead roller 10 a plurality of times. The first manipulation may be stopped when material strip M is at a predetermined remaining length. An adhesive may then be applied to the bottom surface of the predetermined remaining length of material strip M. A second manipulation of bead roller 10 may then be performed by rotating bead roller 10 while simultaneously applying the adhesive to the top surface of the almost formed bead of material. The formed bead may then be removed from bead roller 10.

In accordance with embodiments, a bead roller is provided having compact size that may be stored in storage places of a small size.

In accordance with embodiments, a bead roller is provided that maybe manufactured at a low overall cost.

In accordance with embodiments, a bead roller is provided which permits the manually crafting of one or more beads for a decorative article that does not place undue stress and/or cramping of the fingers and/or hands.

In accordance with embodiments, a bead roller is provided which permits the manually crafting of one or more beads for a decorative article in a reduced amount of time.

In accordance with embodiments, a bead roller is provided which permits the manually crafting of one or more beads for a decorative article with beads of uniform hole size on a consistent basis.

In accordance with embodiments, a bead roller is provided which permits the manually crafting of one or more beads in a more efficient fashion, thereby giving one the capability of creating several decorative articles in one day.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A bead roller adapted to craft a bead from a strip of material, the bead roller comprising:
a handle having a gripping surface adapted to be engaged by a hand of a user of the bead roller; and
a tool arm extending from the handle and having an elongated body with a concave cross-section, and first and second parallel extending edges extending spaced apart along the longitudinal axis of the elongated body to define a slot, each edge having a surface adapted to engage a distal end of the strip of material when the material strip is received in the slot.

2. The bead roller of claim 1, wherein the handle is composed of a wood material.

3. The bead roller of claim 1, wherein the handle is composed of a polymer material.

4. The bead roller of claim 1, wherein the handle is composed of a ceramic material.

5. The bead roller of claim 1, wherein the handle is composed of one of a wood material, a polymeric material, a ceramic material, a composite material and any combination thereof.

6. A bead roller adapted to craft a bead from a strip of material, the bead roller comprising:
a handle having a first handle portion of a first diameter and a second handle portion of a second diameter which is greater than the first diameter, the second handle portion having a having a gripping surface to be engaged by a user of the bead roller; and
a tool arm extending from the first handle portion, the tool arm having a body with a concave cross-section and a first edge extending along the longitudinal axis of the body, a second edge extending along the longitudinal axis of the body and parallel to and spaced apart from the first edge to define a slot sized to receive a end portion of the strip of material, wherein the first edge and the second edge each has a surface adapted to engage a distal end of the strip of material when the material strip is received in the slot.

7. The bead roller of claim 6, wherein the handle is composed of one of a wood material, a polymeric material, a ceramic material, a composite material and any combination thereof.

8. The bead roller of claim 6, wherein handle is composed of a transparent material.

9. The bead roller of claim 6, wherein the handle has a length of 8 inches.

10. The bead roller of claim 6, wherein the second handle portion has a diameter of 0.75 inches.

11. The bead roller of claim 6, wherein the tool arm extends from a distal end of the first handle portion.

12. The bead roller of claim 6, wherein the tool arm is composed of a metal material.

13. The bead roller of claim 6, wherein the tool arm is composed of a polymeric material.

14. The bead roller of claim 6, wherein the tool arm is composed of a composite material.

15. The bead roller of claim 6, wherein the tool arm is composed of one of a metal material, a polymeric material, a composite material and any combination thereof.

16. A bead roller adapted to craft a bead from a strip of material, the bead roller comprising:
a handle having a gripping surface;
a tool arm having a first tool arm portion extending from the handle and a second tool arm portion extending from the first tool arm portion,
wherein the second tool arm portion includes a body having a first edge and a second edge extending along the longitudinal axis thereof, the second edge extending spaced apart from the first edge to define a slot sized to receive an end portion of the strip of material which engages a surface of one of the first edge and the second edge when the material strip is received in the slot.

17. The bead roller of claim 16, wherein the handle is composed of one of a wood material, a polymeric material, a ceramic material, a composite material and any combination thereof.

18. The bead roller of claim 16, wherein the tool arm is composed of one of a metal material, a polymeric material, a composite material and any combination thereof.

19. The bead roller of claim 16, wherein the bead roller has a length of 8 inches.

20. The bead roller of claim 16, wherein the first tool arm portion has a length of 1 inch and the second tool arm portion has a length of 1.5 inches.
